(19) United States
(12) Patent Application Publication
(10) Pub. No.: US 2006/0185080 A1
(43) Pub. Date: Aug. 24, 2006

(54) Method and apparatus to help individuals with limited mobility status

(76) Inventor: Andrew C. Walsh, Falmouth, ME (US)

Correspondence Address: CESARI AND MCKENNA, LLP, 88 BLACK FALCON AVENUE, BOSTON, MA, 02210, US

(21) Appl. No.: 11/063,347

(22) Filed: Feb. 24, 2005

(51) Int. Cl. A61G 7/10

(52) U.S. Cl. 5/89.1

(57) ABSTRACT

Apparatus for assisting an individual with limited mobility status includes a harness adapted to fit around the torso of the individual, an anchoring device attached to the harness, a runner, and a cable having a first end connected to the anchoring device and a second end connected to the runner so that the apparatus supports the individual in an ambulatory fashion.

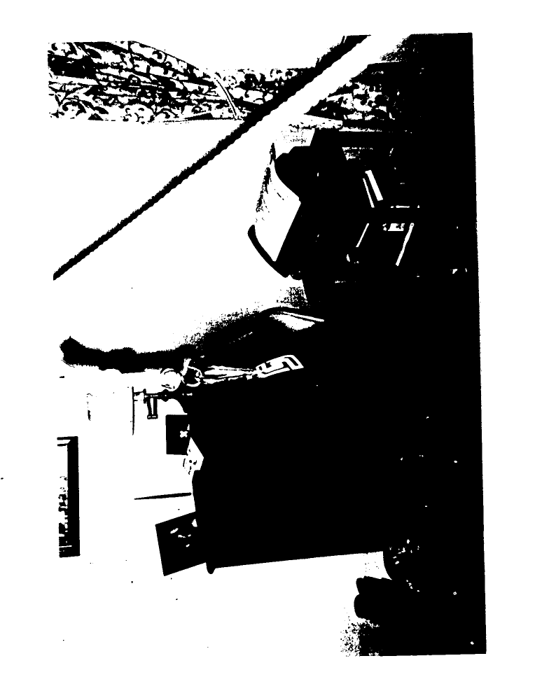

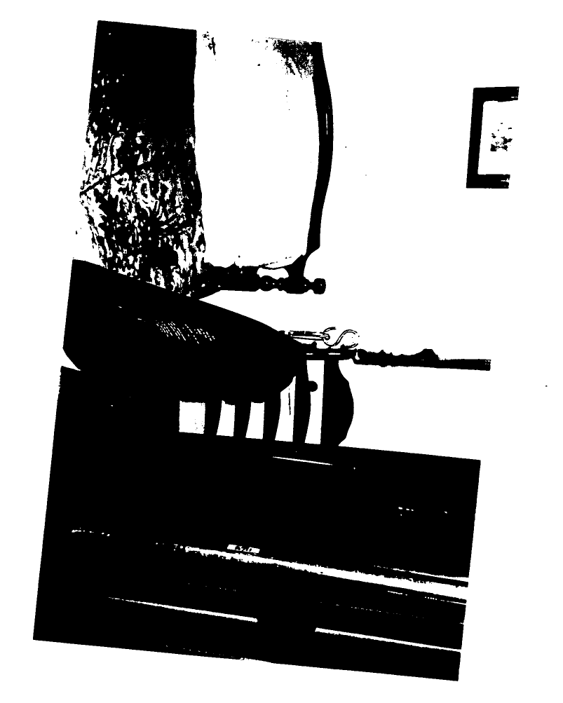

### BACKGROUND OF THE INVENTION

This invention relates to a technique to assist individuals particularly as relates to their declining limitation of mobility. Such limitation may result from aging as older individuals gradually establish declining locomotor skills. Such declining mobility may also be the result of diminishing neuromuscular capacity as possibly relating to progressive mobility deterioration from diseases of the nervous system such as multiple sclerosis.

Locomotor evolution gradually improves from birth. Infants gradually improve from a pronograde status, i.e., moving on all fours to a gradual standing status and progression to limited orthograde status i.e., standing on his or her legs, and also limited hesitant locomotion referred to as Marche de Petit Pas, or in English, short shuffling steps. This to some extent results from gradually improving basal ganglion nervous system improvement through the teens, and early adult mobility allowing profound acrobatic ability as in an Olympic gymnast. Such locomotor skills persist through adulthood only to gradually deteriorate as in the aging population. Such gradual limitation may confine such an individual to bed and constant chair/wheelchair status.

### SUMMARY OF THE INVENTION

Accordingly, this invention aims to help aging or neurologically impaired individuals maintain mobility status without the danger of falling which could cause various traumatic injuries

The invention would allow a limited mobility unit in a nursing or senior citizen home. Nurse involvement in such facilities could render such activities a lot easier for nursing attendant personnel. The specific garment worn by such patients could be attached to cables in limited mobility units and at stairs thereby preventing patients falling with untoward injuries.

The device involves a simple harness unit shaped like a waistcoact with an anterior component and a posterior component to envelop the upper torso and constructed in a soft, though firm, material such as soft leather, with a ring component in the upper dorsal area. The anterior component may be secured to the posterior component by two or three rather wide Velcro straps. The individual, while resting, could open or loosen the anterior component, though, in attempting whatever degree of mobility as possible. Again, the unit would be closed to prevent falling.

A unit in an institution could be referred to as a limited mobility department. Such a department could be staffed by nursing personnel who could assure that patients in such a unit would have my devices properly in place to assist any degree of mobility as attempted by the patients.

Such assist in locomotor function is particularly helpful for aging populations. This is evident as people are increasingly living to much older years which, without the benefit of supports such as this, would result in a bed-bound status or crippling accidents.

My preoccupation with the safety of patients precluded the attention of the bio-architectural components of this concept. I envision a cable system of protection installed in the ceiling of an area of a limited mobility unit. This would allow the handicapped to ambulate in a confined space. The ceiling support entails rectangular beams in the ceiling with cross beams sitting at right angles above threaded inserts which could be marked on the ceiling to which runners could be attached. Alternatively, a walker could be modified to include my device for use in more diverse areas, e.g., shopping malls or even more diverse areas. The concept could also allow the disabled access to traveling, e.g., on recreational vehicles, airplanes, etc.

1.-3. (canceled)

4. Apparatus for assisting an individual with limited mobility status, said apparatus comprising a harness adapted to fit around the torso of the individual, an anchoring device attached to the harness, a runner, and a cable having a first end connected to the anchoring device and a second end connected to the runner so that the apparatus supports the individual in an ambulatory fashion.

5. The apparatus defined in claim 4 wherein the harness has an anterior section and a posterior section and the anchoring device is attached to the posterior section.

6. The apparatus defined in claim 5 wherein said components are releasably connected together by straps.

7. The apparatus defined in claim 5 wherein the anchoring device comprises a ring.

8. The apparatus defined in claim 4 wherein the harness comprises a garment.

9. The apparatus defined in claim 4 wherein the runner is supported by a ceiling beam.
